(19) United States
(12) Patent Application Publication
(10) Pub. No.: US 2004/0020269 A1
(43) Pub. Date: Feb. 5, 2004

(54) Pipeline leak- testing device

(76) Inventor: Michael Brewer, Phoenix, AZ (US)

Correspondence Address: SANDRA L. ETHERTON, ETHERTON LAW GROUP, LLC, PO BOX 27843, TEMPE, AZ, 85285-7843, US

(21) Appl. No.: 10/208,982

(22) Filed: Jul. 31, 2002

(51) Int. Cl. G01M 3/08

(52) U.S. Cl. 73/49.1

(57) ABSTRACT

A device for leak-testing a pipeline system which can be left in place after the test is completed. A bushing—designed to receive a detachable cap—is attached to a wrench collar and a threaded collar, which all share a common axis. A pressure-activated one-way valve seats against a valve seat disposed along the common axis. The threaded collar of the device is coupled to the opening of a test tee. Fluid passes from a source through the one-way valve into the interconnected pipeline system. After the operator completes the testing for leaks in the pipeline system, a cap may be attached to the bushing.

### FIELD OF INVENTION

This invention relates to the testing of any pipeline system for leaks. This invention relates particularly to a permanent leak-testing device that permits the flow of fluid into a pipeline system through the device, and automatically seals itself via a one-way valve to prevent any leakage out of the pipeline system.

### BACKGROUND

In general, the integrity of fluid-based, interconnected pipeline systems must be tested for leaks. This type of testing is applicable to oil pipeline systems, commercial wastewater systems, and residential plumbing systems, among others. During the construction of a building, for example, a plurality of drainage pipes are interconnected so that sewage or waste water may flow from multiple sources down a single drainage system. The pipeline system is inspected for leaks and must pass government inspection before occupancy is permitted.

Pipes for tubs, showers, sinks, and toilets, are interconnected and make a final connection to a stand-pipe or vent stack that extends several feet above ground level. The stand-pipe is coupled to the pipeline system to prevent the formation of a vacuum generated by fluid in the pipes. A test tee is typically installed at the junction between the stand-pipe and the remainder of the pipeline system to create a site for testing the integrity of the system. A conventional test tee includes T or Y fitting in an elongate tubular member, which is permanently installed in the stand-pipe or the stack of sewage sections. The test tee includes an accessible opening, which is conventionally used to isolate a portion of a building's plumbing system with an air-filled balloon or other stopper device or to attach a device for filling the stand-pipe with water. Multiple test tees can be installed throughout large or multi-level pipeline projects to test specific areas.

To test the pipeline system, the stand-pipe is filled with water through the test tee and the pressurized pipeline system is inspected to determine if any leaks exist. Once the inspection of the system is completed, the water is released from the standpipe through the test tee and usually gushes onto the ground or floor.

Various prior art devices have been designed which are removably attachable to the test tee to cap its opening so that the pipeline system stays pressurized until inspected. One such device is a bushing and hose bib arrangement (“bushing/bib”) made of off-the shelf, standardized parts in which a plastic bushing is connected to a brass hose bib (spigot). The bushing/bib is screwed into the opening of the test tee. A plumber fills the pipeline system with water from a garden hose and seals the stand-pipe temporarily by closing the spigot. After the test is complete, the bushing/bib must be removed and replaced with a permanent cap.

One problem with the bushing/bib and other prior art devices is the cost of using these devices. Having a brass component, the bushing/bib is relatively expensive, even though it is reusable. However, the bushing/bib devices are often stolen—after the inspection—before the plumber can return to replace the bushing/bib with an inexpensive, permanent threaded plastic cap to cover the test aperture.

Another problem with the prior art devices is the potential water damage that can occur when the devices are removed after testing. The prior art devices are not designed to be permanent fixtures. When the prior art device is removed—either by a plumber or by a thief—a considerable volume of water flows outward from the opening of the test tee, which sometimes causes flooding and damage to the floor of the building and surrounding areas.

Therefore, it is an object of this invention to provide a leak-testing device that significantly contributes to the ease and low cost involved in the inspection of a pipeline system for leaks. It is a further object of the invention that the leak-testing device may serve as a permanent attachment to the test tee so that removal is not required, thereby avoiding the expenses of having a plumber return to replace it or of having it stolen. It is a further object of this invention to have a leak-testing device made of inexpensive materials.

It is a further object of the invention that the leak-testing device may serve as a permanent attachment to the test tee so that removal is not required, thereby avoiding flooding of the foundation of the building or the area beneath the fluid-based pipeline system.

Another object of the present invention is to provide a leak-testing device that may be attached to the test tee of a pipeline system in such a way that fluid may be channeled through the testing device into the test tee.

It is a further object of the invention that the leak-testing device is leak-proof so that no fluid escapes out of the testing device.

Further objects and advantages of the present invention will become apparent from the study of the following portions of this specification, the claims and the attached drawings.

### SUMMARY OF THE INVENTION

The present invention is a device for leak testing a pipeline system which can be left in place after the test is completed. A bushing—designed to receive a detachable cap—is attached to a wrench collar and a threaded collar, all of which share a common axis. A pressure-activated one-way valve rests against a valve seat disposed along the common axis. The threaded collar of the device is coupled to the opening of a test tee. Fluid passes from the hose through the one-way valve into the interconnected pipeline system. When the operator shuts off the fluid flow, the pressure from the fluid that has been pumped into the pipeline system causes the one-way valve in the device to seat itself across the valve seat, thereby preventing fluid from leaking out the leak-testing device. After the operator completes the testing for leaks in the pipeline system, the hose is removed and a cap may be attached to the bushing. The leak-testing device does not need to be removed—it becomes a permanent fixture.

### BRIEF DESCRIPTION OF THE DRAWINGS

FIG. 1 is a perspective view of the leak-testing device of the invention and a typical tee fitting into which the leak-testing device may be removably attached.

FIG. 2 is perspective view of the leak-testing device and the removable cap of the invention.

FIG. 3 is cross-section view of the leak-testing device of the invention taken along line 3-3 of FIG. 2.

FIG. 4 is a top view of the leak-testing device of the invention.

FIG. 5 is side view of the one-way valve that seats against the valve seat of the invention.

### DETAILED DESCRIPTION OF THE INVENTION

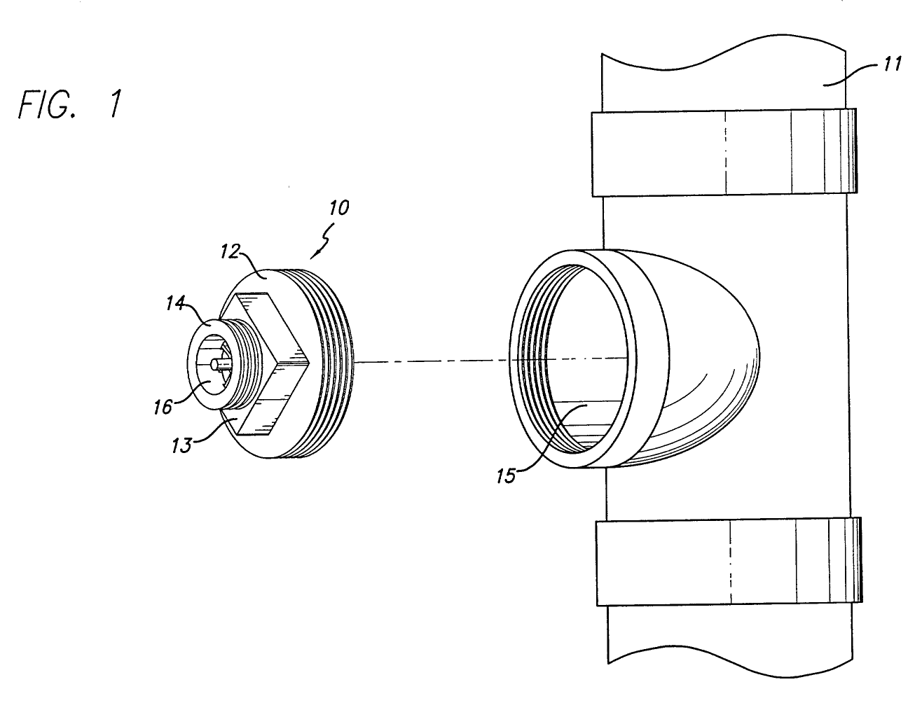

The preferred embodiment of the invention, designated 10, is illustrated with reference to FIGS. 1-5. In FIG. 1, the leak-testing device 10 is shown along with a generic test tee 11 to which the leak-testing device 10 is removably attached at opening 15 of test tee 11. The leak-testing device 10 consists generally of a bushing 14 attached to a wrench collar 13, which is attached to a threaded collar 12. The purpose of wrench collar 13 is to permit a wrench or other tool to tighten threaded collar 12 to test tee 11. Preferably the wrench collar 13 is square, but it could have a different shape, such as hexagonal. Alternatively the wrench collar may be devised with tabs that protrude from the threaded collar for gripping with a wrench or other tool.

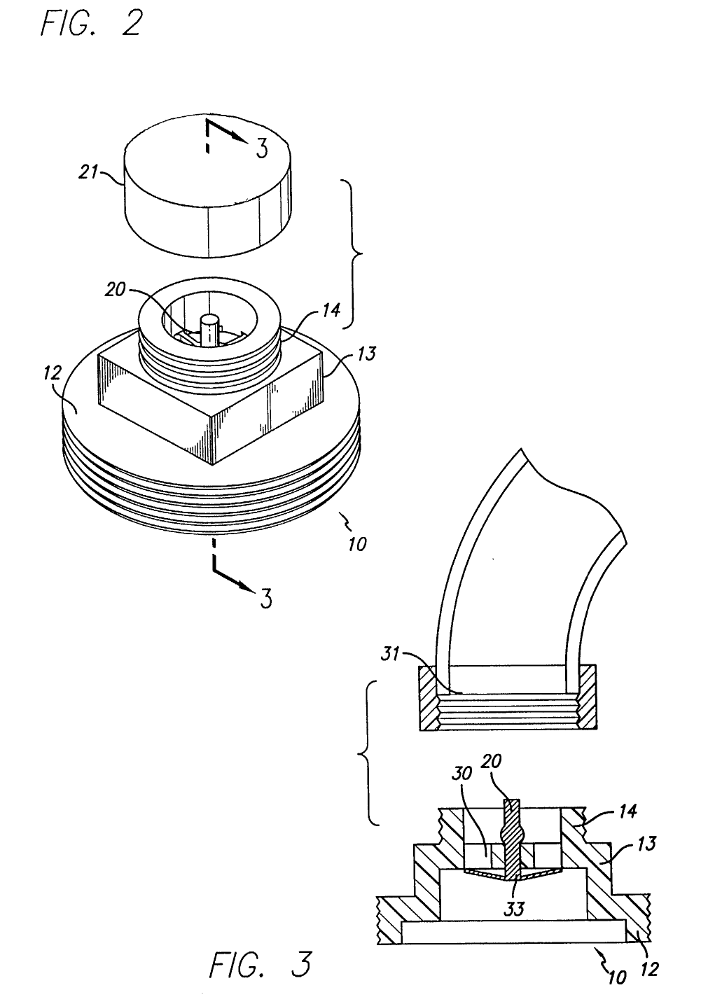

Bushing 14, wrench collar 13, and threaded collar 12 are interconnected along a common axis to form a fluid channel. Valve seat 30 is disposed across the channel and a one-way valve 20 seats against valve seat 30. In the preferred embodiment, the valve seat rests between bushing 14 and wrench collar 13, as shown in FIG. 3. However, the invention could be modified so that the valve seat rests between wrench collar 13 and threaded collar 12. One-way valve 20 is shown in FIGS. 2 and 3. For the preferred embodiment, the one-way valve is an umbrella valve as illustrated in FIG. 5 and described in more detail below. It is apparent that other one-way valves—whether bought off the shelf or custom designed—would also work.

For the purpose of most clearly describing the invention, the preferred embodiment focuses on a leak-testing device for testing the plumbing system of a building for water leaks, although the device could be used on other types of pipeline systems having other types of fluids. In the preferred embodiment, bushing 14 is threaded to accommodate the garden hose nozzle 31, as shown in FIG. 3. However, bushing 14 may consist of any alternative fashion for coupling with a fluid source, such as a snap mechanism with a fluid-tight seal. When water is introduced into the channel, one-way valve 20 is forced open by the pressure of the water as it gushes through valve seat 30. The water pushes one-way valve 20 toward threaded collar 12. When the flow of water stops, the pressure from the water that has entered the pipeline system automatically closes one-way valve 20 by forcing valve head 33 against valve seat 30, thereby sealing the pipeline system so that the system may be tested for leaks.

In the preferred embodiment, a detachable cap 21 screws onto the threaded bushing 14 after the testing of the pipeline system is completed, as shown in FIG. 2. However, detachable cap 21 may be attached by a different mechanism, such as a cotter pin or a snap mechanism.

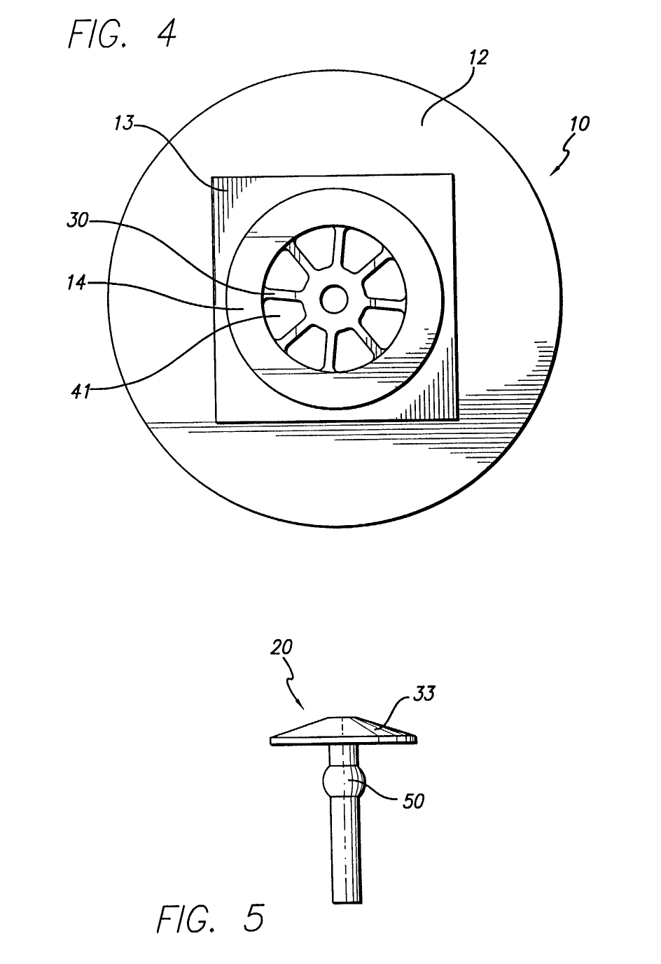

FIG. 4 shows a top view of leak-testing device 10. This view displays the inner workings of valve seat 30. In the preferred embodiment, valve seat 30 has eight triangular-shaped openings 41, but the number and shape of openings can vary.

FIG. 5 shows a side view of one-way valve 20. In the preferred embodiment, one-way valve 20 is an umbrella valve. However, any type of a one-way valve may be utilized. One-way valve 20 is characterized by a raised flange 50, which holds the valve in place. Raised flange 50 permits one-way valve 20 to open sufficiently to allow fluid into the pipeline system while preventing the valve from disengaging from the device and being lost into the pipeline system being tested.

The leak-testing device 10 is preferably made of molded plastic such as ABS or PVC, but may be made of any corrosion-resistant material. For ease of manufacture and to guard against leaks, the bushing, wrench collar and threaded collar are preferably integral with each other.

While there has been illustrated and described what is at present considered to be the preferred embodiment of the present invention, it will be understood by those skilled in the art that various changes and modifications may be made, and equivalents may be substituted for elements thereof without departing from the true scope of the invention. Therefore, it is intended that this invention not be limited to the particular embodiment disclosed as the best mode contemplated for carrying out the invention, but that the invention will include all embodiments falling within the scope of the appended claims.

I claim:

1. A device for a pipeline system comprising:
a) a bushing adapted to receive a detachable cap;
b) a wrench collar; and
c) a threaded collar, wherein the bushing, wrench collar and threaded collar are attached to each other in series about a common axis;
d) a valve seat having at least one aperture disposed between the bushing and the threaded collar; and
e) a one-way valve which seats against the valve seat.

2. The device according to claim 1 further comprising a detachable cap.

3. The device according to claim 1 wherein the bushing is threaded to receive a matedly-threaded detachable cap.

4. The device according to claim 1 wherein the valve seat is disposed between the bushing and the wrench collar.

5. The device according to claim 1 wherein the valve seat is disposed between the wrench collar and the threaded collar.

6. The device according to claim 1 wherein the one-way valve is an umbrella valve that allows fluid to flow in only one direction through the valve seat.

7. A device for leak-testing a pipeline system comprising:
a) a bushing adapted to receive a detachable cap, the bushing having a first channel formed therethrough;
b) a wrench collar having a second channel formed therethrough;
c) a threaded collar having a third channel formed therethrough; wherein the bushing, wrench collar, threaded collar are integral with each other and aligned about a central axis such that fluid may flow into the pipeline system through the first channel, second channel and third channel, in that order;
d) a valve seat having at least one aperture aligned about the central axis disposed between the bushing and the threaded collar; and
e) a one-way valve which seats against the valve seat to prevent fluid flow out of the pipeline system through the valve.

8. The device according to claim 7 wherein the bushing is threaded to receive a matedly-threaded detachable cap.

9. The device according to claim 7 wherein the valve seat is disposed between the bushing and the wrench collar.

10. The device according to claim 7 wherein the valve seat is disposed between the wrench collar and the threaded collar.

11. The device according to claim 7 wherein the one-way valve is an umbrella valve.

12. A method for leak-testing a pipeline system comprising the steps of:
a) attaching to a stand-pipe a leak-test fitting comprising
i. a threaded bushing adapted to receive a matedly-threaded detachable cap, the bushing having a first channel formed therethrough;
ii. a wrench collar having a second channel formed therethrough;
iii. a threaded collar having a third channel formed therethrough; wherein the bushing, wrench collar, threaded collar are integral with each other and aligned about a central axis such that fluid may flow into the pipeline system through the first channel, second channel and third channel, in that order;
iv. a valve seat having multiple apertures aligned about the central axis disposed between the bushing and the wrench collar; and
v. a one-way umbrella valve which seats against the valve seat to prevent fluid flow out of the pipeline system through the leak-test device;
b) attaching a fluid source to the bushing and substantially filling the pipeline system with fluid;
c) attaching the matedly-threaded detachable cap to the threaded bushing;
d) checking the pipeline system for leaks; and
e) leaving the leak-test device in place wherein the one-way umbrella valve prevents backflow of any water that has already entered the standpipe.
